(19) United States
(12) Patent Application Publication
(10) Pub. No.: US 2024/0145914 A1
(43) Pub. Date: May 2, 2024

(54) 3D ANTENNA RADAR DEVICE, ANGLE DETECTION SYSTEM AND ANGLE DETECTION METHOD

(71) Applicant: Megasense Technology Corp., Zhubei (TW)

(72) Inventor: Hsin-Lung Hsiao, Hsinchu (TW)

(21) Appl. No.: 18/052,197

(22) Filed: Nov. 2, 2022

(51) Int. Cl. H01Q 3/30; H01Q 1/24

(52) U.S. Cl. CPC H01Q 3/30; H01Q 1/247

(57) ABSTRACT

A three-dimensional (3D) radar device for 3D angle detection is illustrated. The 3D radar device has M transmitting antennae, N receiving antennae and a radio frequency integrated circuit (RFIC). The M transmitting antennae is controlled to be form beamforming radiation patterns in different transmitting and receiving period periods, wherein the beamforming radiation patterns are formed on a first plane, and the beamforming radiation patterns in the different transmitting and receiving period periods scan a second plane being vertical to the first plane. The N receiving antennae form N receiving radiation patterns at the same time to cover a third plane being vertical to the first plane and the second plane. The RFIC has an antenna phase adjuster to adjust phases of the M transmitting antennae, wherein M and N are integer larger than or equal to 2.

### BACKGROUND

### Technical Field

The present disclosure relates to a three-dimensional (3D) antenna radar technology, and particularly to, a 3D antenna radar device, an angle detection system and method, each of which is able to detect a horizontal angle and a vertical angle of a target in respective to the 3D radar device at the same time with less antennae area, or to achieve the more precise angle detection with the same antennae area of the prior art.

### Related Art

A distance, a speed and an angle are the three most important factors in a radar detection field. Accuracy and resolution are indicators used to evaluate performance factors. The accuracy and the resolution of the distance and the speed are usually determined by the variations of a transmitted waveform in a frequency and a time, while the accuracy and the resolution of the angle are determined by a number of physical antennae. Regarding the angle detection in the radar field, the general practice is to use multiple receiving antennae, and use the beamforming generated by multiple receiving antennae to determine a 3D angle (comprising a vertical angle and a horizontal angle) of the target in respective to a radar device. Under one dimension (horizontal or vertical direction), the more the receiving antennae are, the higher the angle accuracy and resolution can be obtained, but the larger the relative hardware area is.

Another requirement is that the horizontal and vertical angles must be provided at the same time. To provide horizontal and vertical detection functions at the same time, the architecture must be expanded into a two-dimensional antennae combination (i.e. a number of the receiving antennae will be N*N, wherein N are numbers of the receiving antennae in horizontal and vertical directions), or two set of one-dimensional antennae (i.e. the receiving antennae in horizontal and vertical directions, a number of the receiving antennae will be N+N) must be integrated, so as to detect the 3D angle of the target in space, but the above two manners need to be considered for the area requirements of the hardware antennae and microwave components. Though the antennae area cost of the manner of integrating two set of one-dimensional antennae is less than that of the manner of the two-dimensional antenna combination, the resolution of the manner of integrating two set of one-dimensional antennae is lower than that of the manner of the two-dimensional antenna combination. Further, regardless the area cost of the antennae, extra RF components of down-converting RF signals to baseband signals for processing are required.

The publication of US 2016/0103213 utilizes a two-dimensional antenna array to respectively detect a distance, a distance variation rate, a horizontal angle and a vertical angle, and then matches the horizontal angle and the vertical angle via a matching manner, so as to obtain a 3D coordinate point of a target, wherein numbers of a transmitting antenna and receiving antennae are respectively 1 and N*N. The issued patent of U.S. Pat. No. 9,739,881 B1 utilizes two set of independent linear antennae array to detect a horizontal angle and a vertical angle, and then matches the horizontal angle and the vertical angle via a matching manner, so as to obtain a 3D coordinate point of a target, and numbers of a transmitting antenna and receiving antennae are respectively 2 and N+N. The issued patent of U.S. Pat. No. 9,121,930 B2 utilizes two different transmitting antennae to generate two vertical radiation patterns, and utilizes receiving antennae to provide a horizontal angle and a vertical angle of a target. The design of U.S. Pat. No. 9,121,930 B2 utilizes merely two transmitting antennae in the vertical direction and N receiving antennae, and though the detection accuracy of the vertical angle is dependent on the angle estimation manner, a resolution of the vertical angle is limited by the two physical antennae since the two radiation patterns are fixed.

### SUMMARY OF THE PRESENT DISCLOSURE

According to at least one objective of the present disclosure, an embodiment of the present disclosure provides a three-dimensional radar device. The 3D radar device comprises M transmitting antennae, N receiving antennae and a radio frequency integrated circuit (RFIC). The M transmitting antennae is controlled to be form beamforming radiation patterns in different transmitting and receiving period periods, wherein the beamforming radiation patterns are formed on a first plane, and the beamforming radiation patterns in the different transmitting and receiving period periods scan a second plane being vertical to the first plane. The N receiving antennae form N receiving radiation patterns at the same time to cover a third plane being vertical to the first plane and the second plane. The RFIC comprises an antenna phase adjuster to adjust phases of the M transmitting antennae, wherein M and N are integer larger than or equal to 2. For example, M is 3, 6, 12, 24 or any number of transmitter antennas, and N is 4, 8 16, 32 or any number of receiver antennas.

According to at least one objective of the present disclosure, an embodiment of the present disclosure provides an angle detection system using the above 3D radar device.

According to at least one objective of the present disclosure, an embodiment of the present disclosure provides an angle detection method using the above angle detection system.

To sum up, compared with the prior art, the number of the total required antennae is M+N, the required area cost is decreased, and the resolution can be increased.

### BRIEF DESCRIPTION OF THE DRAWINGS

The present disclosure can be more fully understood by reading the subsequent detailed description and examples with references made to the accompanying drawings, wherein dimensions and arrangement configurations in the drawings are for illustration only, and the present disclosure is not limited thereto. Each figure of the drawings is briefly illustrated as follows.

FIG. 1 is a block diagram of an angle detection system according to an embodiment of the present disclosure.

FIG. 2 is a schematic diagram showing a variation of a beamforming radiation pattern generated by M transmitting antennae according to an embodiment of the present disclosure.

FIG. 3A through FIG. 3D are schematic diagrams respectively showing N receiving radiation patterns generated by N receiving antennae according to an embodiment of the present disclosure.

FIG. 4 is a schematic diagram showing four beamforming radiation patterns generated by M transmitting antennae at different times according to an embodiment of the present disclosure.

FIG. 5 is a schematic diagram showing four beamforming radiation patterns generated by N receiving antennae at the same time according to an embodiment of the present disclosure.

FIG. 6 is a schematic diagram showing three combined radiation patterns generated by M transmitting antennae and N receiving antennae at different times according to an embodiment of the present disclosure.

FIG. 7 is a flow chart of an angle detection method according to an embodiment of the present disclosure.

### DETAILS OF EXEMPLARY EMBODIMENTS

The following description is of the best-contemplated mode of carrying out the present disclosure. This description is made for the purpose of illustrating the general principles of the present disclosure and should not be taken in a limiting sense. The scope of the present disclosure is best determined by reference to the appended claims.

To solve the problems of the related art, embodiments of the present disclosure provide a 3D antenna radar device, an angle detection system and method. The 3D radar device or the angle detection system of the embodiment of the present disclosure has an antennae area than that of the prior art, and thus the product adopts the technology of the present disclosure can utilize a software or hardware to control M transmitting antennae (p.s. M is an integer larger than or equal to 2) to generate different beamforming radiation patterns at different times, and utilize N receiving antennae (p.s. N is an integer larger than or equal to 2) to generate multiple receiving radiation patterns at the same time. Each of the different beamforming radiation patterns at different times can be seen as a scanning radiation pattern each time. The scanning radiation pattern and the receiving radiation patterns of the N receiving antennae thus form a combined radiation pattern, thus there are different combined radiation patterns at different times, and a vertical angle and a horizontal angle of a target can be detected by using merely one set of the M transmitting antennae and one set of the N receiving antennae. Further, the adjustable beamforming manner is performed on the M transmitting antennae by using the software or hardware (especially, the software), and the beamforming radiation patterns of the M transmitting antennae at different times point to different directions to scan a first vertical plane (X-Z plane), therefore being helpful to increase the accuracy and resolution of the angle detection.

In short, the improved antennae array and time division multiple access (TDMA) mechanism are used in the present disclosure, and during a transmitting and receiving period (p.s. the present disclosure for example takes the transmitting and receiving period as a unit time of the TDMA manner), phases of the M transmitting antennae are controlled by a programmable phase rotator in a beamforming control manner, such that the beamforming radiation pattern pointing to one direction is formed on a horizontal plane (X-Y plane), and radio frequency (RF) waves are radiated by the M transmitting antennae with the beamforming radiation pattern to a target. Still in the transmitting and receiving period, the receiving radiation patterns generated by the N receiving antennae can cover a second vertical plane (Y-Z plane) to receive RF waves reflected from the target at the same time. Accordingly, by using the technology provided by the present disclosure, the beamforming radiation patterns of the M transmitting antennae with different phases which point different directions at different times can be used to scan whole ranges of the target in ultrashort time, and the N receiving antennae which form receiving radiation patterns to cover the second vertical plane (Y-Z plane) can receive the reflected RF waves at same time, therefore providing a better angle resolution with less antennae and a less antennae module area.

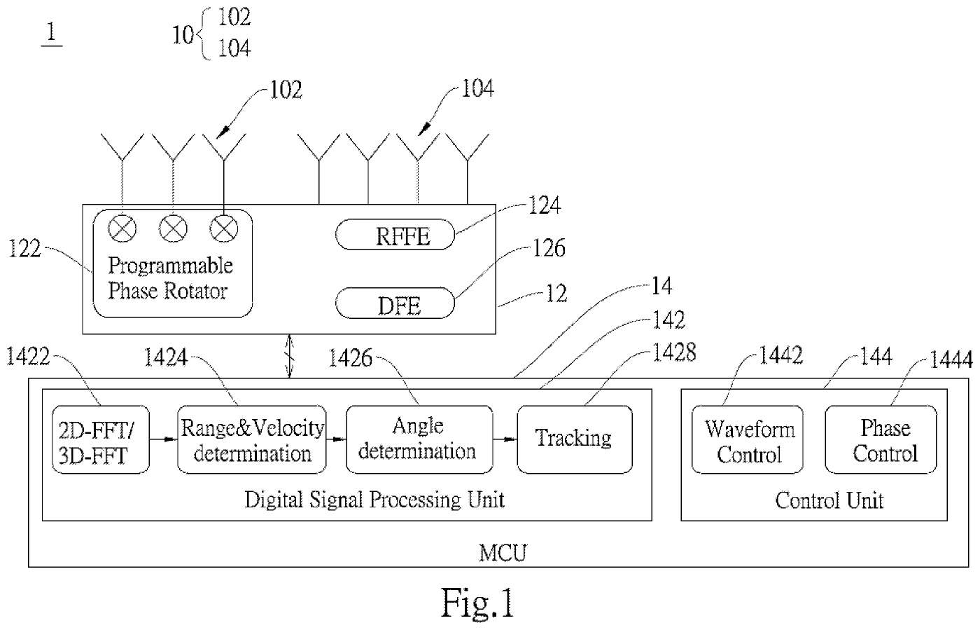

Referring to FIG. 1, and FIG. 1 is a block diagram of an angle detection system according to an embodiment of the present disclosure. The angle detection system 1 comprises an antennae module 10, a RF integrated circuit (RFIC) 12 and a microcontroller unit (MCU) 14, wherein the antennae module 10 is electrically connected the RFIC 12, and the RFIC 12 is electrically connected to the MCU 14. The RFIC 12 and the antennae module 10 form a 3D radar device which adopts TDMA manner to generate beamforming radiation patterns on a horizontal plane (X-Y plane) at different times to radiate RF waves to a target, wherein each time the beamforming radiation pattern points to a direction, and thus the beamforming radiation patterns pointing to different directions at different times are used to scan the a vertical plane (Y-Z plane). The 3D radar device further generates multiple receiving radiation patterns which cover a second plane (X-Z plane) at the same time, the receiving patterns are substantially fixed, and the receiving radiation patterns can receive the reflected RF waves from the target.

The antennae module 10 comprises M transmitting antennae 102 (for example, M=3) and N receiving antennae 104 (for example, N=4). The numbers of N and M of the present disclosure are larger than or equal to 2, and the case of M=3 and N=4 is just an example for descriptions. In other one embodiment, M can be 3, 6 or 12, and N can be 4, 8 or 16. The RFIC 12 comprises a programmable phase rotator 122, a RF front-end circuit (RFFE) 124 and a digital front-end circuit (DFE) 126, wherein the programmable phase rotator 122 is electrically connected to the M transmitting antennae 102, the RFFE 124 is electrically connected to the N receiving antennae 104, and the DFE 126 is electrically connected to the RFFE 124.

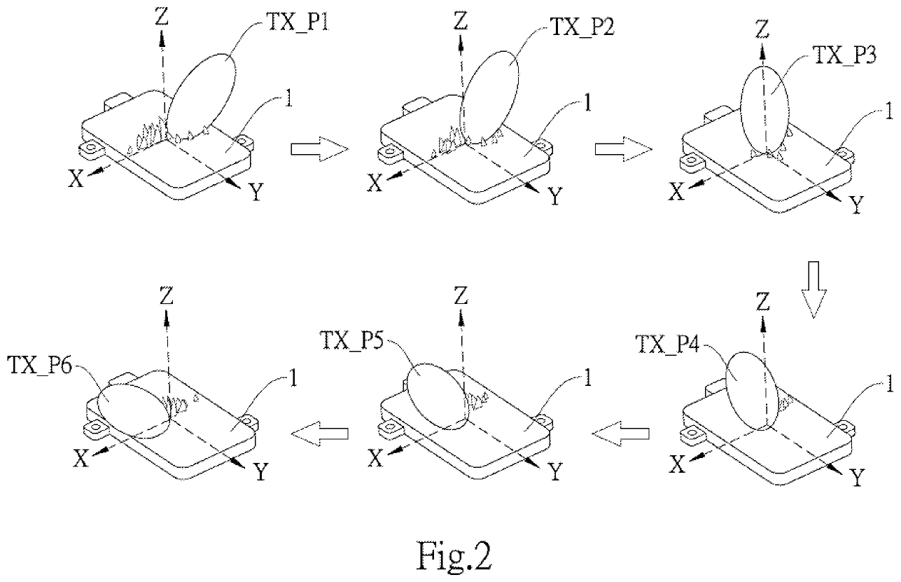

Refer to FIG. 2 and FIG. 1 at the same time, and FIG. 2 is a schematic diagram showing a variation of a beamforming radiation pattern generated by M transmitting antennae according to an embodiment of the present disclosure. The programmable phase rotator 122 is used to control the phases of the M transmitting antennae 102, such that the M transmitting antennae 102 produce a beamforming radiation pattern on a horizontal plane (X-Y plane) each transmitting and receiving period, and the beamforming radiation patterns on the horizontal plane (X-Y plane) in different transmitting and receiving periods point to different directions. It is noted that the programmable phase rotator 122 can be replaced by an antenna phase adjuster of any kind.

As shown in FIG. 2, at the first transmitting and receiving period, the generated beamforming radiation pattern TX_P1 on the horizontal plane (X-Y plane) point to a first direction of a first vertical plane (X-Z plane). Next, at the second transmitting and receiving period, the generated beamforming radiation pattern TX_P2 on the horizontal plane (X-Y plane) point to a second direction of the first vertical plane (X-Z plane). That is, the generated beamforming radiation patterns TX_P1 through TX_P6 in the six transmitting and receiving periods respectively point to the different directions of the first vertical plane (X-Z plane), so as to scan the first vertical plane (X-Z plane). For example, when a phase rotator has a resolution of 5.625 degrees, the generated beamforming radiation patterns TX_P1 through TX_P6 in the six transmitting and receiving periods respectively have +/−5.625, +/−11.25, +/−16.875 degrees in respective to the X axis, that is, the first vertical plane (X-Z plane) is scanned in sequence. However, that the scanning is performed via a specific rule or randomly is not a limitation of the present disclosure, and the number of the generated beamforming radiation patterns is not limited to only 6.

The RFFE 124 comprises an amplifier, a mixer, an oscillator, a variable gain amplifier and a phase locked loop (PLL), so as to process signals of RF waves received by the N receiving antennae 104. The DFE 126 comprises a filter and a down-converter, receives the signal from the RFFE 124, and performs the filtering and down-conversion.

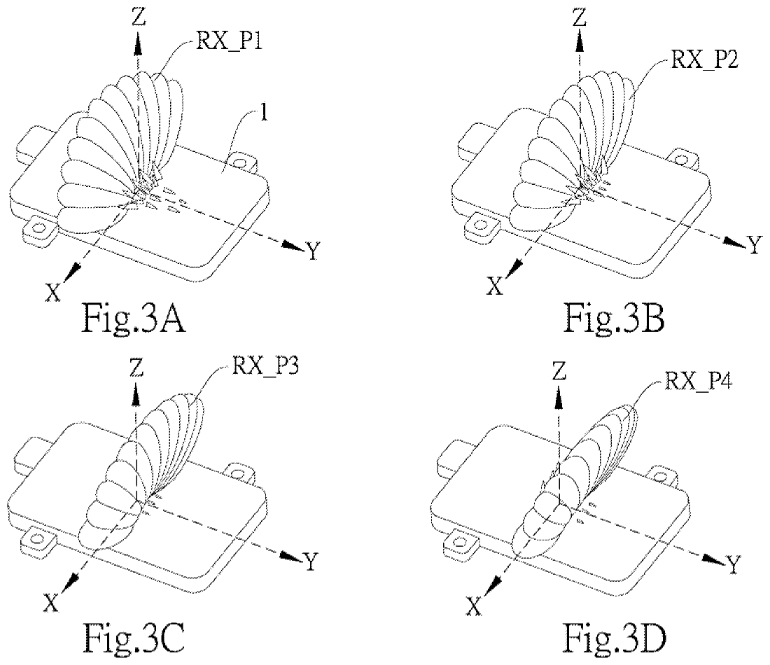

Refer to FIG. 3A through FIG. 3D and FIG. 1, FIG. 3A through FIG. 3D are schematic diagrams respectively showing N receiving radiation patterns generated by N receiving antennae according to an embodiment of the present disclosure. In the embodiment, N is 4, and the four receiving radiation patterns RX_P1 through RX_P4 in FIG. 3A through FIG. 3D generated by the N receiving antennae 104, the four receiving radiation patterns RX_P1 through RX_P4 on the horizontal plane (X-Y plane) cover the whole second vertical plane (Y-Z plane).

In short, phases of the M transmitting antennae 102 can be controlled for beamforming to generate different beamforming radiation patterns pointing to different directions at different times (i.e. the directionality of the beamforming radiation pattern of the M transmitting antennae 102 can be adjusted when the phases of the of the M transmitting antennae 102 are adjusted), and the phases of the N receiving antennae 104 are fixed without the beamforming and scanning functions, but the four receiving radiation patterns RX_P1 through RX_P4 have different directionalities, so as to cover the second vertical plane (Y-Z plane). Accordingly, by using the above manner, the 3D radar device equivalently forms a set of two-dimensional antennae with an antennae area of M+N antennae.

Still refer to FIG. 1, the MCU 14 comprises a digital signal processing unit 142 and a control unit 144. The control unit 144 is electrically connected to the programmable phase rotator 122, and used to control the programmable phase rotator 122 to change the phases of the M transmitting antennae 102. The digital signal processing unit 142 is electrically connected to the DFE 126 to receive the processed signal of the DFE 126, so as to calculate a vertical angle and a horizontal angle of the target in respective to the 3D radar device.

The digital signal processing unit 142 comprises multiple function modules 1422, 1424, 1426 and 1428. The function module 1422 is used to perform 2D a fast Fourier transform (2D FFT) or a 3D FFT on the processed signal of the DFE 126, so as to obtain a frequency-domain signal. The function module 1424 determines a range (i.e. distance) and velocity of the target according to the frequency-domain signal. The function module 1426 calculates the vertical angle and the horizontal angle of the target according to the frequency-domain signal. The function module 1428 is used to track the target according to the frequency-domain signal. The control module 144 comprises multiple control modules 1442 and 1444. The control module 1442 is used to control the RF waves which the M transmitting antennae 102 to radiate, and the control module 1444 is used to control the programmable phase rotator 122 to change the phases of the M transmitting antennae 102.

It is noted that the main beam of the beamforming radiation pattern and the main beam of the receiving radiation pattern have the similar thickness (for example, larger than 20 degrees), and each of the M transmitting antennae 102 and each of the N receiving antennae 104 can be the antennae of the same kind, for example, the patch antennae. Further, under the TDMA mechanism, the transmitting and receiving period can be 2 micro-seconds. After the scanning is completed, the mapping results of the transmitting and receiving can be finished (i.e. the combination of the beamforming radiation patterns is essentially overlapped with the combination of the receiving radiation patterns).

In an example, the frequency of the RF waves can be 77 GHz (i.e. the antennae are designed to receive and transmit the RF waves of 77 GHz), M is designed to be 6 and N is designed to be 8. Each adjacent twos of the six transmitting antennae 102 have a distance of half wavelength of 77 GHz therebetween, and the six transmitting antennae 102 have phase differences for beamforming. In addition to the antenna gain due to the concentration of the beamforming, since the six transmitting antennae 102 radiate energy of the RF waves at the same time, it adds extra 7.7 dB gain. Further, the design of six transmitting antennae 102 should consider the field of view (FOV) of the eight receiving antennae 104, and thus, the length of the six transmitting antennae 102 should be design to be shorter. To form different receiving radiation patterns, the beam tilting angles of the eight receiving antennae 104 should be different in the second vertical plane (Y-Z plane), and that is the eight receiving antennae 104 have different antenna lengths. By designing the above eight receiving antennae 104, the eight receiving antennae 104 can cooperate with the scanning of the six transmitting antennae 102 for the 3D angle detection. The distance between two adjacent transmitting antennae of the conventional multiple input and multiple output (MIMO) system should be N times the half wavelength of the operating frequency. However, in the present disclosure, the adjacent twos of the six transmitting antennae 102 have a distance of the half wavelength of the operating frequency. Accordingly, the area can be saved, and the area of the circuit board can be controlled to be under 50 mm*90 mm.

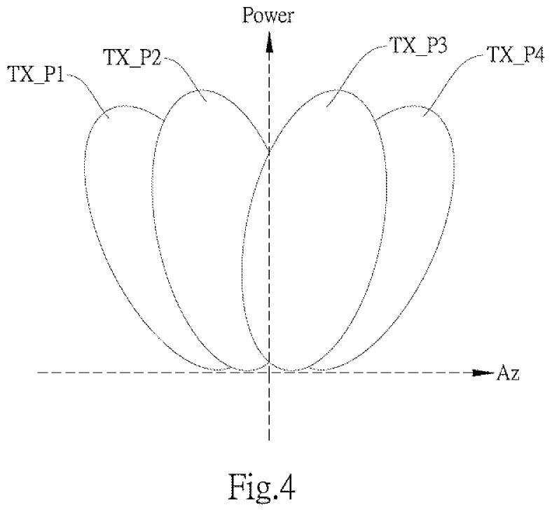

Referring to FIG. 4, and FIG. 4 is a schematic diagram showing four beamforming radiation patterns generated by M transmitting antennae at different times according to an embodiment of the present disclosure. In FIG. 4, the horizontal axis is azimuth (marked with Az) and the vertical axis is power. In the embodiment, the TDMA manner is utilized, and thus the beamforming radiation patterns TX_P1 through TX_P4 formed respectively in the first through fourth transmitting and receiving periods, so as to scan first vertical plane (X-Z plane).

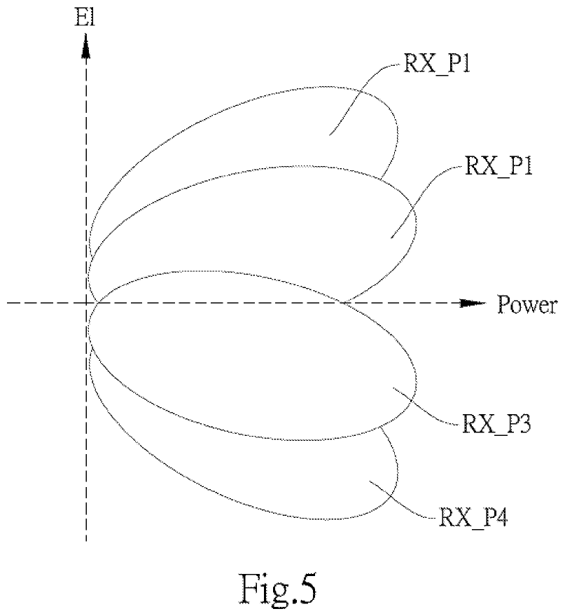

Refer to FIG. 5, and FIG. 5 is a schematic diagram showing four beamforming radiation patterns generated by N receiving antennae at the same time according to an embodiment of the present disclosure. In FIG. 5, the vertical axis is elevation (marked with E1) and the horizontal axis is power. Generally, the receiving radiation pattern of the receiving antenna is determined when manufactured, and that is the N receiving antennae may have the same receiving radiation patterns if no modification is performed. To make the 3D radar device have the detection ability of the two-dimensional antennae, the N receiving antennae are designed to have different antenna lengths, such that the receiving radiation patterns RX_P1 through RX_P4 of the receiving antennae point to different directions. For example, the receiving radiation patterns RX_P1 through RX_P4 respectively have the angles of 2.5 degrees, 10 degrees, −10 degrees and −2.5 degrees in respective to the vertical axis.

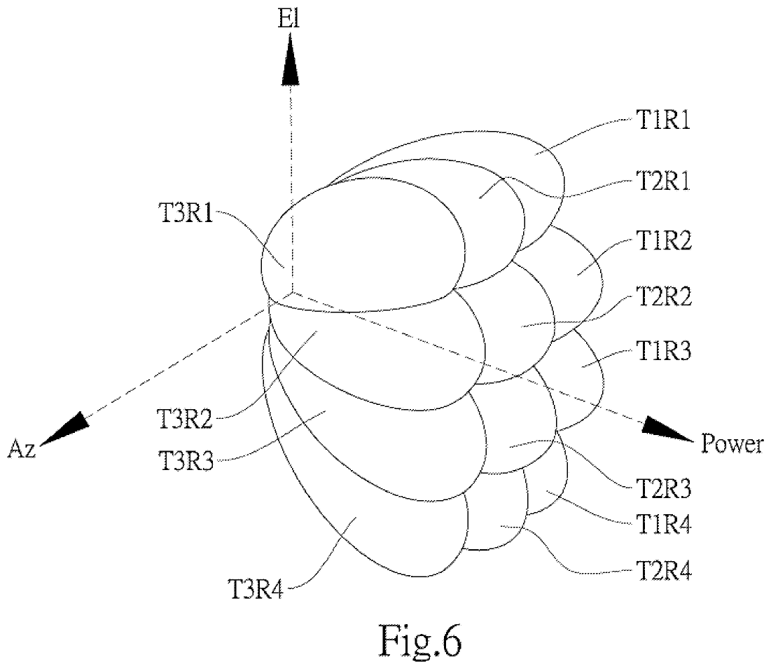

Refer to FIG. 6, and FIG. 6 is a schematic diagram showing three combined radiation patterns generated by M transmitting antennae and N receiving antennae at different times according to an embodiment of the present disclosure. The M transmitting antennae is for scanning the first vertical plane (X-Z plane) and the N receiving antennae is for covering the second vertical plane (Y-Z plane), by combining the M transmitting antennae and the N receiving antennae, the combined radiation patterns at different times are shown in FIG. 6. At a first transmitting and receiving period, the combined radiation pattern comprises the radiation patterns T1R1, T1R2 and T1R3. At a second transmitting and receiving period, the combined radiation pattern comprises the radiation patterns T2R1, T2R2 and T2R3. At a third transmitting and receiving period, the combined radiation pattern comprises the radiation patterns T3R1, T3R2 and T3R3. In short, the 3D radar device can equivalently provide the 3D beamforming waves pointing to the different directions associated with the vertical and horizontal angles with the less number of the total antennae.

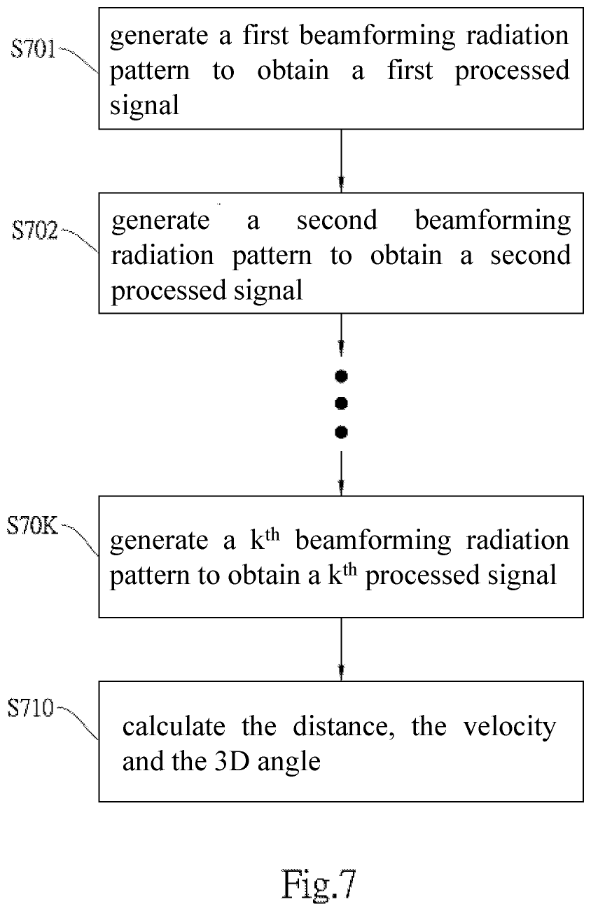

Refer to FIG. 7, and FIG. 7 is a flow chart of an angle detection method according to an embodiment of the present disclosure. The angle detection method comprises steps S701 through S710. At step S701, the M transmitting antennae of the 3D radar device is configured to generate a first beamforming radiation pattern to emit the RF waves to the target, all of the N receiving antennae of the 3D radar device are used to generate N receiving radiation patterns to receive the RF waves reflected from the target, and the 3D radar device processes the signals of the RF waves reflected from the target to generate a first processed signal. At step S702, the M transmitting antennae of the 3D radar device is configured to generate a second beamforming radiation pattern to emit the RF waves to the target, all of the N receiving antennae of the 3D radar device are used to generate N receiving radiation patterns to receive the RF waves reflected from the target, and the 3D radar device processes the signals of the RF waves reflected from the target to generate a second processed signal.

At step S70K, the M transmitting antennae of the 3D radar device is configured to generate a k^{th} beamforming radiation pattern to emit the RF waves to the target, all of the N receiving antennae of the 3D radar device are used to generate receiving radiation patterns to receive the RF waves reflected from the target, and the 3D radar device processes the signals of the RF waves reflected from the target to generate a k^{th} processed signal. It is noted that, the first through k^{th} beamforming radiation patterns scan the first vertical plane (X-Z plane) and the N receiving radiation patterns covers the second vertical plane (Y-Z plane), such that the first through k^{th} processed signals have the information of the vertical angle and the horizontal angle of the target, wherein k is an integer larger than or equal to 2. Next, at step S710, the MCU is used to calculate the distance, the velocity and the 3D angle (comprising the horizontal and vertical angles) of the target in respective to the 3D radar device according to the first through k^{th} processed signals.

To sum up, compared to the prior art, the 3D radar device of the present disclosure utilizes the TDMA manner to make the M transmitting antennae form beamforming radiation patterns at different times for scanning the first vertical plane (X-Z plane), and utilizes the N receiving antennae form receiving radiation patterns for covering the second vertical plane (Y-Z plane), so as to detect the 3D angle of the target in respective to the 3D radar device. Thus, the number of the total required antennae is M+N, the required area cost is decreased, and the resolution can be increased.

While the present disclosure has been described by way of example and in terms of preferred embodiment, it is to be understood that the present disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A three-dimensional (3D) radar device, comprising:
M transmitting antennae, controlled to be form beamforming radiation patterns in different transmitting and receiving period periods, wherein the beamforming radiation patterns are formed on a first plane, and the beamforming radiation patterns in the different transmitting and receiving period periods scan a second plane being vertical to the first plane;
N receiving antennae, forming N receiving radiation patterns at the same time to cover a third plane being vertical to the first plane and the second plane; and
a radio frequency integrated circuit (RFIC), electrically connected to the M transmitting antennae and the N receiving antennae, comprising an antenna phase adjuster to adjust phases of the M transmitting antennae, wherein M and N are integer larger than or equal to 2.

2. The 3D radar device of claim 1, wherein the antenna phase adjuster is a programmable phase rotator.

3. The 3D radar device of claim 1, wherein the RFIC further comprises a radio frequency front-end circuit (RFFE) and a digital front-end circuit (DFE) for processing signals of RF waves received by the N receiving antennae.

4. The 3D radar device of claim 3, wherein the RFFE comprises an amplifier, a mixer, an oscillator, a variable gain amplifier and a phase locked loop (PLL), and the DFE comprises a filter and a down-converter.

5. The 3D radar device of claim 1, wherein M is 3, 6, 12 or 24, and N is 4, 8 16 or 32.

6. The 3D radar device of claim 1, wherein the N receiving antennae have different antenna lengths.

7. An angle detection system, comprising:
a three-dimensional (3D) radar device, comprising:
M transmitting antennae, controlled to be form beamforming radiation patterns in different transmitting and receiving period periods, wherein the beamforming radiation patterns are formed on a first plane, and the beamforming radiation patterns in the different transmitting and receiving period periods scan a second plane being vertical to the first plane;
N receiving antennae, forming N receiving radiation patterns at the same time to cover a third plane being vertical to the first plane and the second plane; and
a radio frequency integrated circuit (RFIC), electrically connected to the M transmitting antennae and the N receiving antennae, comprising an antenna phase adjuster to adjust phases of the M transmitting antennae, wherein M and N are integer larger than or equal to 2; and
a microcontroller unit (MCU), electrically connected to the 3D radar device, calculating a vertical angle and a horizontal angle of a target in respective to the 3D radar device based on RF waves received by the N receiving antennae and reflected from the target.

8. The angle detection system of claim 7, wherein the antenna phase adjuster is a programmable phase rotator.

9. The angle detection system of claim 7, wherein the RFIC further comprises a radio frequency front-end circuit (RFFE) and a digital front-end circuit (DFE) for processing signals of the RF waves received by the N receiving antennae.

10. The angle detection system of claim 9, wherein the RFFE comprises an amplifier, a mixer, an oscillator, a variable gain amplifier and a phase locked loop (PLL), and the DFE comprises a filter and a down-converter.

11. The angle detection system of claim 7, wherein M is 3, 6, 12 or 24, and N is 4, 8 16 or 32.

12. The angle detection system of claim 7, wherein the N receiving antennae have different antenna lengths.

13. The angle detection system of claim 7, wherein the MCU comprises a digital signal processing unit, and the digital signal processing unit comprises multiple function modules for performing 2D or 3D fast Fourier transform, range and velocity determination of the target, angle determination of the target and tracking of the target.

14. The angle detection system of claim 7, wherein the MCU comprises a control unit, and the control unit comprises multiple control modules for controlling RF waves which the M transmitting antennae to radiate and controlling the antenna phase adjuster.

15. An angle detection method, using an angle detection system comprising a three-dimensional (3D) radar device, comprising steps of:
making the M transmitting antennae of the 3D radar device be configured to generate a x^{th} beamforming radiation pattern to emit RF waves to a target in a x^{th} transmitting and receiving period, all of N receiving antennae of the 3D radar device generate N receiving radiation patterns at the same time to receive the RF waves reflected from the target, and making the 3D radar device process signals of the RF waves reflected from the target to generate a x^{th} processed signal, wherein x is an integer from 1 to k, and k is an integer larger than or equal to 2, wherein the first through k^{th} beamforming radiation patterns and N receiving radiation patterns are formed on a first plane, the first through k^{th} beamforming radiation patterns in the first through k^{th} transmitting and receiving periods scan a second plane being vertical to the first plane and the N receiving radiation patterns covers a third plane being vertical to the first plane and the second plane; and
calculating a distance, a velocity, a horizontal angle and a vertical angle of the target in respective to the 3D radar device according to the first through k^{th} processed signals.
